(19) United States
(12) Patent Application Publication
(10) Pub. No.: US 2003/0200822 A1
(43) Pub. Date: Oct. 30, 2003

(54) Oil field sample apparatus

(76) Inventor: Timothy Layton, Alberta (CA)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/134,162

(22) Filed: Apr. 25, 2002

(51) Int. Cl. G01N 1/20

(52) U.S. Cl. 73/864.63; 73/863.86

(57) ABSTRACT

A sampling apparatus comprising a beaker having an integral base and transparent sidewall, and a removable cap engagable with the sidewall. The cap provides a male bayonet nipple extending outwardly. The bayonet nipple has a terminal annular lip with protuberances extending radially outward and adapted for press-fit interconnection with a sampling port of an oil handling system.

### BACKGROUND OF THE INVENTION

1. Field of the Invention

This invention relates generally to industrial sampling especially in oil fields and more particularly to a sampling apparatus with novel connection feature.

2. Description of Related Art

The following art defines the present state of this field:

Schwartz et al., U.S. Pat. No. 4,279,355 describes a container comprising an open-topped cylindrical container body having a pair of tabs on the upper end of the outside, and a removable cylindrical resilient cap, having a sidewall with vertical grooves on the inside matching the tabs in location, but closer together diametrically than are the tabs. The cap is deformable to accommodate the tabs. The sidewall also has a pair of about horizontal arcuate grooves extending from the vertical grooves larger diametrically than the vertical grooves to receive the tabs. The horizontal grooves may narrow as they diverge from the vertical grooves. The cap cannot be removed from the container body without first rotating the cap to free the wedged tabs, then ovaling the cap to allow the cap to be rotated to a position where the vertical grooves and tabs are aligned, whereupon the cap can be lifted off the container body.

Mohlmann, U.S. Pat. No. 4,336,890 describes a closure for a tube or bottle. The closure includes a cup-shaped cap that fits over the opening of the tube or bottle, a tubular closure member that is mounted around the cap, and a plurality of ribs that connect the cap and the closure. The cap and the closure are radially spaced and the ribs extend at a slant or pitch angle relative to a radial line. The ribs all slant in one direction when the closure is in the open or at-rest position. To seal the opening, the member is turned angularly to decrease the pitch angle, which action bends or flexes the cap radially inwardly against the tube or bottle. The member is turned sufficiently far to bend the ribs over center so that they slant in the opposite direction, in order to lock the closure on the cap or closure.

Schmidt, U.S. Pat. No. 4,759,274 describes a coffee maker including a housing which supports a fresh water container above a receptacle for the coffee. A resistive heating element is mounted in the container to heat the water. The bottom of the container is provided by a downwardly sloping element having an outlet to release heated water to a filter vessel which is releasably connected to the bottom element by a bayonet lock. The filter vessel has an upper rim which is pressed toward an annular shoulder on the underside of the bottom element to create a seal, so that a bubble forms beneath the bottom element when coffee is being brewed. The upper side of the bottom element has arms which mount a temperature-sensitive bimetallic snap element over the outlet. A resilient stopper is mounted on the snap element and is raised from the outlet by the snap element when the water is hot enough for coffee.

Gagnon et al., U.S. Pat. No. 5,072,850 describes a trash can wherein the open top of the container is surrounded by a ring-shaped rim having two inwardly extending prongs forming part of a bayonet mount. The lid of the can has a top portion and a depending annular skirt which can be inserted into the rim preparatory to activation of the bayonet mount which further comprises two inverted L-shaped slots in the external surface of the skirt. The lower ends of the slots are open to permit entry of prongs in response to placing of the lid onto the rim, and the lid is then turned relative to the container in order to cause the prongs to enter the substantially horizontal portions of the respective slots. The bayonet mount ensures that the lid cannot be separated from the container by dogs, bears, raccoons and/or other animals. In addition, the bayonet mount can maintain the top portion of the lid in substantial sealing engagement with the rim to prevent the escape of odors and/or flowable substances. The slots are disposed at the ends of a substantially diametrically extending grip at the upper side of the top portion of the lid to thus facilitate proper orientation of the lid prior to its connection to the container.

Teague et al., U.S. Pat. No. 5,102,001 describes a lid-to-container locking assembly for lock sealing containers utilized in the transporting, storage and disposal of low level radioactive contaminated material. The locking assembly gives visual indications of a locked, sealed condition of the container through the utilization of a closure element that is ensconced in a latched position upon the lid to be secured, as well as to the container to be sealed. Detachment of the closure element at either of these points of its locking engagement with the lid and/or container will visually indicate an open and unsealed condition.

Goldenberg, U.S. Pat. No. 5,123,556 describes a non-openable container such as for disposal of medical waste or containment of hazardous materials. The container is adapted for optional engagement with a removable cap prior to insertion of medical waste or hazardous materials and with a non-openable and non-breachable, one-way engaging cap which renders the container non-openable except with destruction of the container. To ensure secure non-openable closure of the container, the peripheral edge of the skirt of the one-way cap has a plurality of circumferentially arranged ramped teeth extending longitudinally on the interior wall of the cap to the lower edge of the skirt. These teeth cooperatively engage oppositely extending teeth on a shoulder of the container or other peripherally extending fixed-in place element. The opposing teeth mesh longitudinally and are held in a non-back-off position by the engaged threads, bayonet mount or other engaging means between the cap and container. The teeth are not externally accessible and attempted deformation of the cap and container causes them to move, if at all, as a unit without disengagement of the intermeshed teeth. The container and cap are constructed of break resistent low-deformable material to resist breakage and manipulative disengagement of the cap from the container.

Bauer, U.S. Pat. No. 5,232,115 describes a non-openable container such as for disposal of medical waste or containment of hazardous materials. The container is adapted for optional engagement with a removable cap prior to insertion of medical waste or hazardous materials and with a non-openable and non-breachable, one-way engaging cap which renders the container non-openable except with destruction of the container. To ensure secure non-openable closure of the container, the peripheral edge of the skirt of the one-way cap has a plurality of circumferentially arranged ramped teeth extending longitudinally on the interior wall of the cap to the lower edge of the skirt. These teeth cooperatively engage oppositely extending teeth on a shoulder of the container or other peripherally extending fixed-in place element. The opposing teeth mesh longitudinally and are held in a non-back-off position by the engaged threads, bayonet mount or other engaging means between the cap and container. The teeth are not externally accessible and attempted deformation of the cap and container causes them to move, if at all, as a unit without disengagement of the intermeshed teeth. The container and cap are constructed of break resistent low-deformable material to resist breakage and manipulative disengagement of the cap from the container.

Schutz, U.S. Pat. No. 5,368,182 describes a lid seal for wide-mouthed barrels blow-molded of a synthetic resin utilizes a solid sealing ring of plastic, this ring being in contact with the underside of a solid flange projecting radially outwardly at a spacing below the barrel opening from the barrel wall, as well as a counter ring, likewise produced of plastic, this counter ring resting on a flange molded on the bottom to the outer lid rim. Locking sleeves are formed on the clamping rings, distributed about the circumference, these sleeves engaging in corresponding bores in the barrel flange and in the lid flange. The clamping rings and the locking sleeves molded thereon have conical aligned through bores. For closing the lid placed on the wide-mouthed barrel, clamping bolts of plastic or metal are pressed, by a pressing tool, from above into the conical bores of the two clamping rings. The ring in contact with the barrel border is supported by a corresponding device. On account of the clamping force exerted by the clamping bolts, the lid gasket is pressed against the opening rim of the barrel neck.

Griffin, et al., U.S. Pat. No. 5,395,004 describes a quick-on cap for engaging a filler neck. The cap includes a closure for closing the mouth of the filler neck and a gripping mechanism for gripping the filler neck to establish a fuel vapor seal between the closure and the filler neck. The closure includes a core and a sleeve that is movable relative to the core. The sleeve carries a sealing ring that is configured to seal against the filler neck. The gripping mechanism is coupled to the core and sleeve and grips the filler neck to compress the sealing ring between the sleeve and the filler neck in response to movement of the core relative to the sleeve in a cap-installation direction. The closure also includes a handle cover coupled to the core to make it easy for a user to move the core relative to the sleeve in the cap-installation direction an amount sufficient to actuate the gripping mechanism. The sleeve is formed to include a passageway extending therethrough and containing the cylindrical core. The core is rotated a fraction of a turn relative to the sleeve to actuate the gripping mechanism.

Shamis, U.S. Pat. No. 5,529,202 describes a closure for a container having a lid combining positively interengaging latches with a biasing feature which urges the lid upward with respect to the container in order to more firmly effect latching. A series of projections formed along the interior upper periphery of the container register with latching slots formed along the outer surface of a skirt which depends from the lid, which is dimensioned to fit closely within the opening of the container. An annular flange extends from the outermost periphery of the lid to overlap a portion of the skirt. The outer upper periphery of the container is tapered outwardly to force the flange to flex when the lid is placed on the container thus imparting an upward force to the lid and, thereby, to the lug-and-latch combinations when the lid is turned to register the lugs with the latches. A handle assembly is attachable to the exterior of the container. Other embodiments include use of the closure on medicine vials as a child-resistant closure, and on overcontainers for carrying dangerous or hazardous materials.

Bradshaw, U.S. Pat. No. 5,605,244 describes a blow molded plastic container and lid combination wherein a bayonet type thread lock mechanism is provided between an exterior skirt portion of the lid and an interior side wall portion of the container to secure them together. The lid is further provided with a circumferential perimeter overhang that has an inverted U-shaped rim channel above this bayonet type thread lock mechanism for circumferentially receiving and engaging the top end of the container. An inwardly directed annular shoulder is also provided on the container side wall between this bayonet thread lock mechanism and the top end portion of the container whereby a split ring clamp circumferentially secures the chime area of the lid and container combination in sealed engagement. The split ring clamp has an inwardly open U-shaped channel for engaging this container annular shoulder and also circumferential top portions of the lid to clamp them together in vertical compressed engagement.

Bates, U.S. Pat. No. 5,920,333 describes a system for ensuring that the correct container containing a replenishment fluid is connected to a vessel for that fluid. The container carries one component of a pair of axially engageable members. The other is carried by the vessel, notably around the necks extending therefrom, so that the members have to engage and nest so as to allow the necks of the container and the vessel to engage fully and thus mount the container on the vessel, one of the members being a moveable fit upon the container or vessel, preferably by virtue of being a snap fit thereon, so that the member can be rotated to align its projections with the recesses on the other member. The invention is of especial application in ink jet printers to identify solvent and ink refill bottles and ensure that they are connected to the correct reservoir and by the use of the snap fit members allows a conventional refill bottle and reservoir to be used to achieve this.

The prior art teaches receptacles for foodstuffs, containers with closure locking means, fuel caps, replenishment reservoirs, container closures, lid seals, and safety caps, but does not teach a sampling container adapted for receiving an oil field sample through a bayonet connector. The present invention fulfills these needs and provides further related advantages as described in the following summary.

### SUMMARY OF THE INVENTION

The present invention teaches certain benefits in construction and use which give rise to the objectives described below.

An oil field sampling apparatus comprises a beaker having an integral base and transparent sidewall, and a removable cap engagable with the sidewall. The cap provides a male bayonet nipple extending outwardly from an upper surface. The bayonet nipple has a pair of protuberances extending radially outward in opposing positions and adapted for press-fit and turn interconnection with a sampling port of an oil handling system. The apparatus, therefore, can be quickly engaged with a valve spout for receiving an oil sample, and then disengaged for analysis. A cap cover is used to maintain cleanliness in the sample.

A primary objective of the present invention is to provide an apparatus and method of use of such apparatus that provides advantages not taught by the prior art.

Another objective is to provide such an invention capable of being pressed into and removed from the sampling port by snap-action.

A further objective is to provide such an invention capable of receiving oil samples when attached to the sampling port.

A still further objective is to provide such an invention capable of maintaining cleanliness of an oil sample.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of the preferred embodiment of the invention apparatus with a dust cover of the invention mounted on the apparatus;

FIG. 2 is similar to FIG. 1 with the dust cover removed;

FIG. 3 is similar to FIG. 2 showing the apparatus mounted onto a sampling valve port which is not part of the invention; and

FIG. 4 is a close-up view of FIG. 3 showing details of mounting the invention apparatus onto the sampling port.

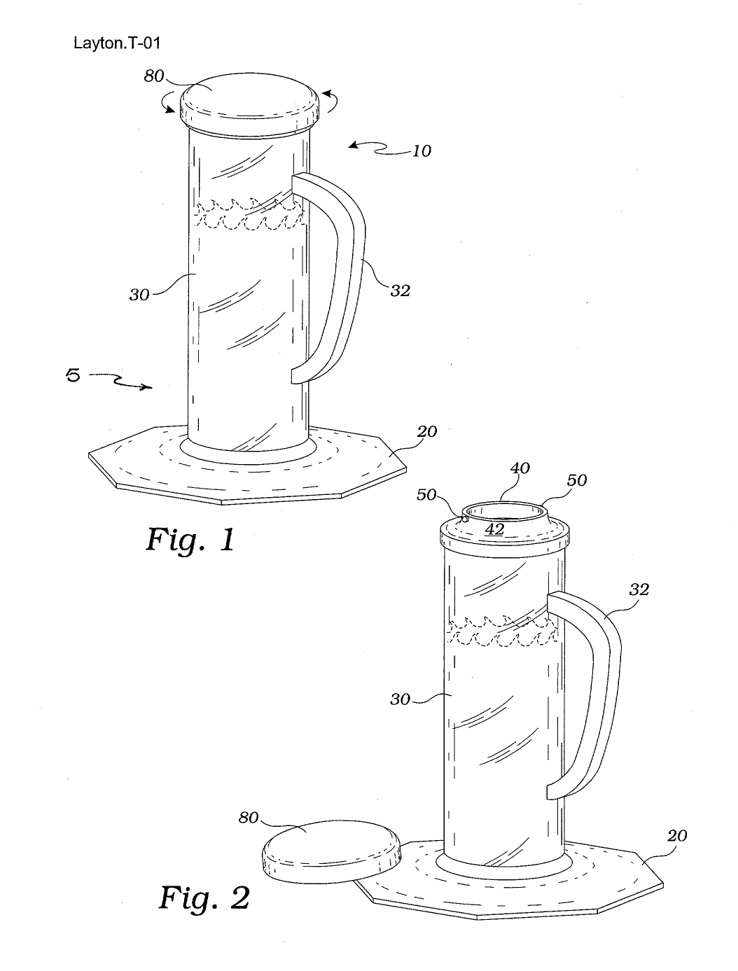

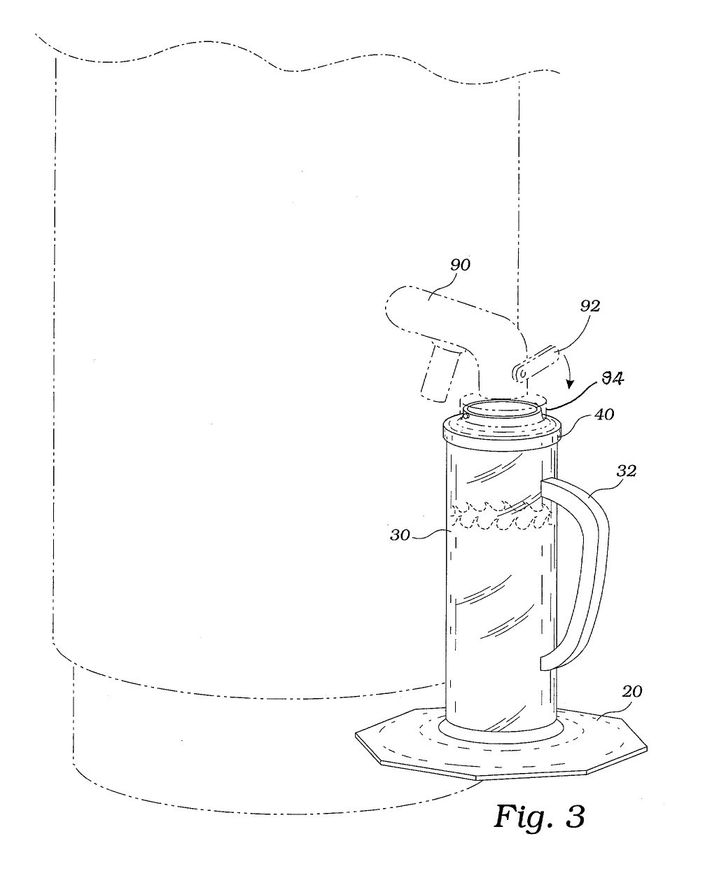

### DETAILED DESCRIPTION OF THE INVENTION

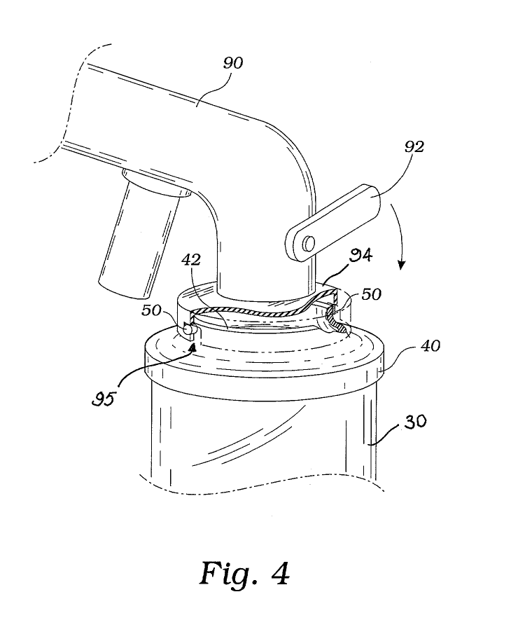

The above described drawing figures illustrate the invention in at least one of its preferred embodiments, which is further defined in detail in the following description. A sampling apparatus 5, preferably made of plastic or glass or similar material, comprises in combination: a beaker 10 having an integral base 20 and a transparent sidewall 30 so as to be able to see an oil sample and its level within the beaker 10. A removable cap 40, preferably of injection molded plastic, is engagable with the sidewall 30 by threading means such as male and female threads respectively, as is very well known. The cap 40 provides a wide-mouthed, outwardly extending lip 42, which has radially positioned and laterally extending protuberances 50. A sampling valve port 90 provides a receiver 92 adapted by its shape and size for accepting the lip 42. The receiver 94 has L-slots 95 adapted for accepting the protuberances 50 as the lip 42 is inserted into the L-slots 95 and locking the protuberances 50 as the sampling apparatus is rotated about its vertical axis, as best shown in FIG. 4.

The sidewall preferably further comprises a handle 32 adapted for lifting and rotating the apparatus by hand. This handle 32 preferably comprises a U-shape and is preferably positioned vertically on the sidewall 30, although alternate handle configurations may be applied as is well known in the art.

A dust cover 80 is disk-shaped and adapted by its shape and compliant material, for snapping over the cap 40 so as to provide a dust seal to prevent soiling of the oil sample and the cap.

With the sampling apparatus 5 mounted in the receiver 94, a valve handle 92 is rotated to allow sample fluid to flow into the apparatus 5. To remove the apparatus 5, it is rotated within the L-slots 95 and then drawn downwardly until the protuberances 50 are clear of the L-slots 95. The valve port 90 provides a fluid exit pipe outlet that is smaller than the inner diameter of the lip 42 so that fluid is able to flow into the beaker 10, without spilling.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A sampling apparatus which comprises in combination: a beaker having an integral base and a transparent sidewall; a removable cap, provides a wide-mouthed, outwardly extending lip, with radially positioned and laterally extending protuberances; a sampling valve port providing a receiver adapted by its shape and size for accepting the lip and protuberances within L-shaped slots adapted for accepting the protuberances as the lip is inserted into the receiver, and locking the protuberances by rotation of the beaker.

2. The combination of claim 1 further comprising a handle adapted for lifting and rotating the apparatus by hand.

3. The combination of claim 2 wherein the handle is of a U-shape and positioned vertically on the sidewall.

4. The combination of claim 1 further comprising a dust cover of a compliant material adapted for snapping over the cap to provide a dust seal thereto.
